(19) United States
(12) Patent Application Publication
(10) Pub. No.: US 2001/0017233 A1
(43) Pub. Date: Aug. 30, 2001

(54) Rung ladder in composite material

(75) Inventor: Luca Panzeri, Lomagna (IT)

Correspondence Address: LAFF,WHITESEL & SARET, LTD., Attorneys at Law, 401 North Michigan Avenue, Chicago, IL, 60611, US

(73) Assignee: GENEX S.r.I

(21) Appl. No.: 09/790,835

(22) Filed: Feb. 22, 2001

(30) Foreign Application Priority Data
Feb. 24, 2000 (EP) 00830133.5

(51) Int. Cl. E06C 7/00

(52) U.S. Cl. 182/228.6; 182/228.2

(57) ABSTRACT

A ladder made of composite material comprises a plurality of rungs having an elongated body (19) provided with at least one connecting portion (3) adapted to engage an upright (4) of a ladder. Engagement means (5) locks the rung (2) to the upright (4); this means comprises a coupling element (6) made by co-moulding on the connecting portion (3) of the elongated body (19) or, alternatively, on the connecting seating (20) of the upright (4), a mechanical fastener (9) operatively acting in an installation housing (8) of the coupling element (6) and a locking element (10) adapted to prevent disengagement of the mechanical fastener (9). The ladder (1) is made through the following steps: arranging the rungs (2), simultaneously arranging a pair of uprights (4), associating the coupling elements (6) either with the connecting portions (3) of the rungs or with the connecting housings (20) on the uprights and finally rigidly linking rungs (2) and uprights (4) together by screws (9) provided with locking screw anchors (10) fitted in the installation housings (8).

### FIELD AND BACKGROUND OF THE INVENTION

The present invention relates to a ladder of composite material, comprising an elongated body having at least one connecting portion adapted to engage an upright and a coupling element associated at its end with the connecting portion of the elongated body.

It is known that composite materials have particular mechanical features associated with a great lightness-in-weight, and therefore lend themselves to be advantageously used in many different production fields; in ladder production, the composite materials enable manufactured articles to be made that are able to withstand the user's weight while being at the same time very light-in-weight, which will allow portable use of same. In addition, the composite materials find useful application in the manufacture of ladders for particular utilizations, for instance where electrotechnical works are concerned in which the operator's safe electrical insulation from the ground is required.

Ladders of composite material made following the known art contemplate the presence of a pair of uprights and a plurality of rungs in the form of section members: these rungs are transversely fitted between the two uprights. Depending on the specific techniques and the use for which the ladder is intended, different patterns of the manufactured article can be accomplished, all of them being however characterized by the presence of at least one element consisting of a pair of uprights joined to each other by a plurality of transverse rungs fitted thereto.

During the assembling step, the rungs must be conveniently arranged so as to enable insertion of same into the uprights; for carrying out this operation, the known art substantially contemplates the following steps: machining of the rung ends that must be usually shaped in a form adapted for fitting to the upright; insertion of a connecting element into an assembling seating provided on the ladder upright; fitting of a connecting element of matching shape on the rung end; carrying out of a final assembling by means of a fastening element operating between the two connecting elements fitted to the upright and to the rung end, respectively. An alternative assembling procedure involves gluing of the rung ends, still after machining of said ends so that they may adapt themselves to the assembling seating formed on the upright.

Although the devices in accordance with the known art briefly described above are widely used, they however have some drawbacks.

In fact, as can be easily understood from the preceding description, the traditional assembling processes involve an important burden in terms of additional machining operations, since there are rung parts and upright parts that must be conveniently arranged for installation of the connecting means; this brings about an extension of the production times. These machining operations further involve preparation of the connecting elements to be installed to the rung ends and on the upright respectively, which are embodied by a pair of suitably shaped male/female connectors for example, thereby involving an increase in the production costs.

A further drawback is represented by the fact that, in the particular case of assembling by gluing or at all events by chemical processes, the possibility of dismantling the rung is irreversibly lost, if for instance one of them is to be replaced because it is faulty; in this case, even if a single rung has structural defects, the whole ladder is to be discarded.

In addition, since rungs cannot be dismantled, it is impossible to carry out transportation of the ladder in a disassembled configuration, for saving room for example, and subsequently reassemble it in case of need; furthermore, the user cannot replace the faulty rungs by himself/herself.

### SUMMARY OF THE INVENTION

Under this situation, the technical task underlying the present invention is to devise a ladder comprising: a plurality of rungs having each at least one respective connecting portion, at least one upright provided with a plurality of connecting seatings, a plurality of coupling elements interposed each between the connecting portion of a respective rung and the corresponding connecting seating on the upright for connection of said rungs to the connecting seatings of the upright, said ladder showing a great mechanical strength associated with an intrinsic lightness-in-weight and simultaneously having controlled production costs.

In addition, it is an aim of the present invention to provide a ladder offering an important constructional simplicity, taking into account the number and structure of the connecting elements between rung and upright.

It is a further aim of the invention to provide a ladder ensuring the possibility of dismantling it and replacing one or more rungs in case of structural faults or breaking without being obliged to discard the whole manufactured article.

The technical task mentioned and the aims specified are substantially achieved by a ladder in accordance with the invention, wherein said coupling element is made by co-moulding on said connecting portion or said connecting seating.

### BRIEF DESCRIPTION OF THE DRAWINGS

Description of a preferred but not exclusive embodiment of a ladder in accordance with the present invention is now given hereinafter by way of non-limiting example, illustrated in the accompanying drawings, in which:

FIG. 1 is a cross-sectional view of a rung installed on an upright of a ladder in accordance with the invention;

FIG. 2 is view of the rung-upright assembly seen from the left side in FIG. 1;

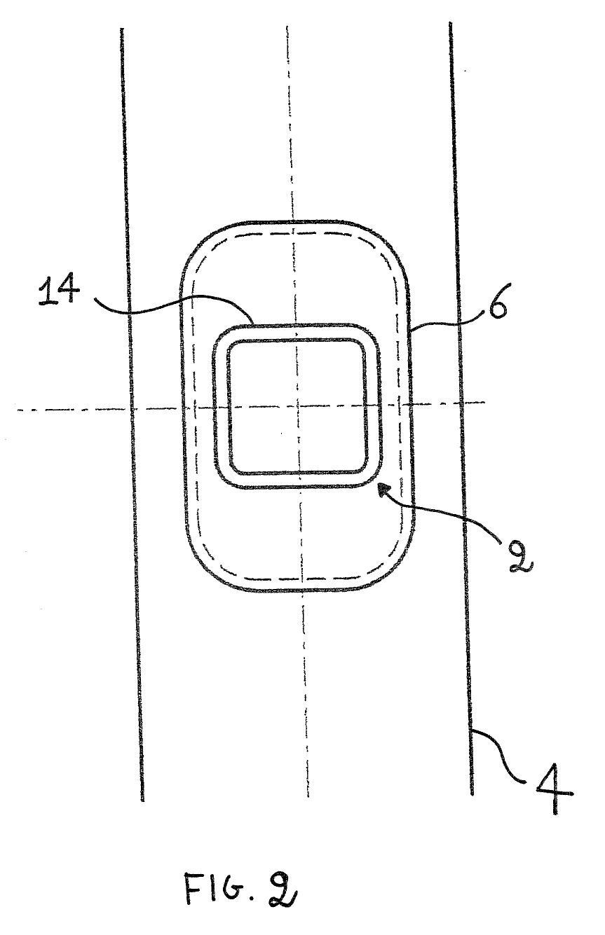

FIG. 3 is a view of the rung-upright assembly seen from the right side in FIG. 1;

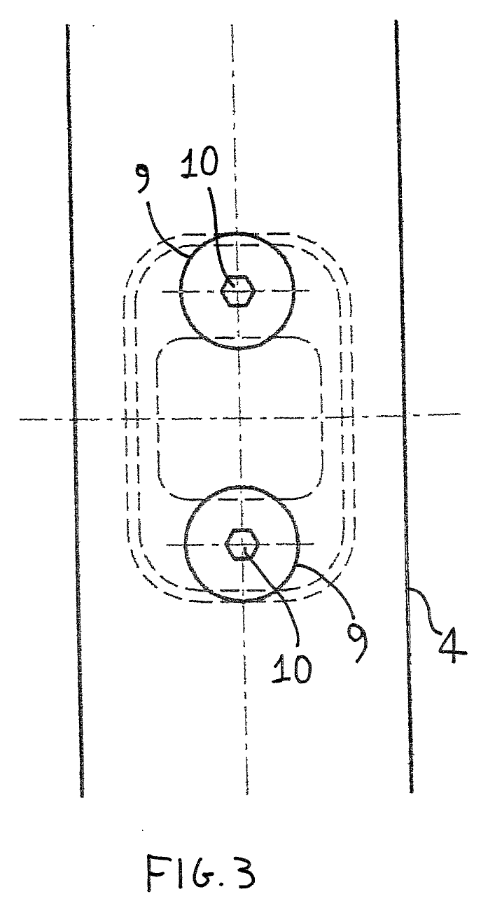

FIG. 4 is a flow diagram of the manufacturing line of the rungs in accordance with the invention;

FIG. 5 is a flow diagram of the assembling line of the ladders in accordance with the present invention;

FIGS. 6, 7, 8, 9, 10 and 11 show some possible embodiments of the section of the rung seen in FIG. 1;

FIGS. 12 and 13 show some possible embodiments of the section of the upright seen in FIG. 1;

FIG. 14 shows an alternative embodiment of the rung-upright assembly of a ladder in accordance with the invention, seen in cross section.

### DESCRIPTION OF THE PREFERRED EMBODIMENTS

With reference to the drawings, the ladder in accordance with the invention is generally identified by reference numeral 1.

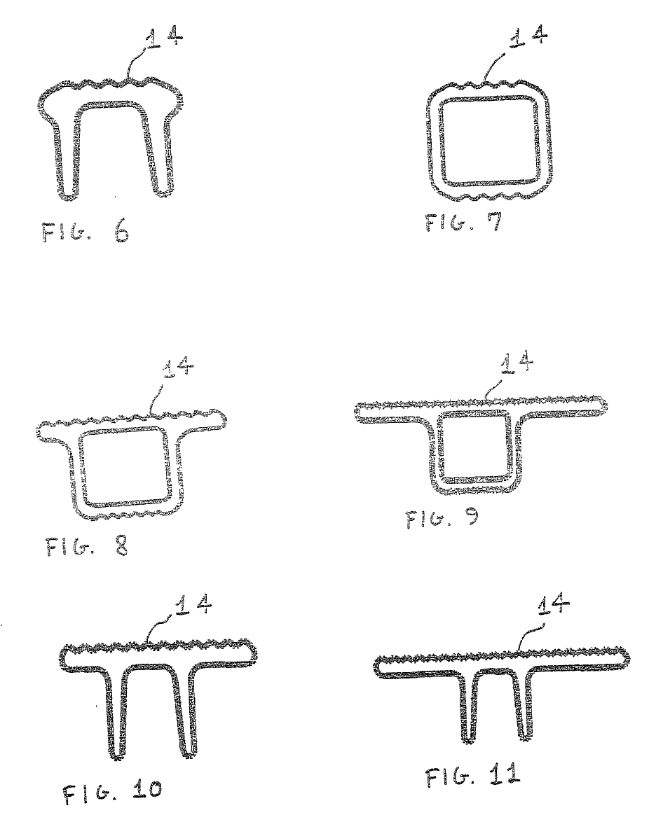

The rung comprises an elongated body 19 having at least one connecting portion 3 adapted to engage an upright 4 of a ladder. This elongated element 2 is made of a plastic resin incorporating reinforcing fibres, fibreglass for example, is substantially in the form of a section member, and preferably has a tubular shape. At all events, as can be viewed from FIGS. 6 to 11, the rung can be of any section, provided it is adapted to withstand the stresses to which it is submitted. Still in connection with said figures, a substantially flat rest surface 14 can be defined in the rung section, said surface being intended for support of the user's feet. This rest surface is such oriented that it is almost horizontal relative to the ground when the ladder is being used.

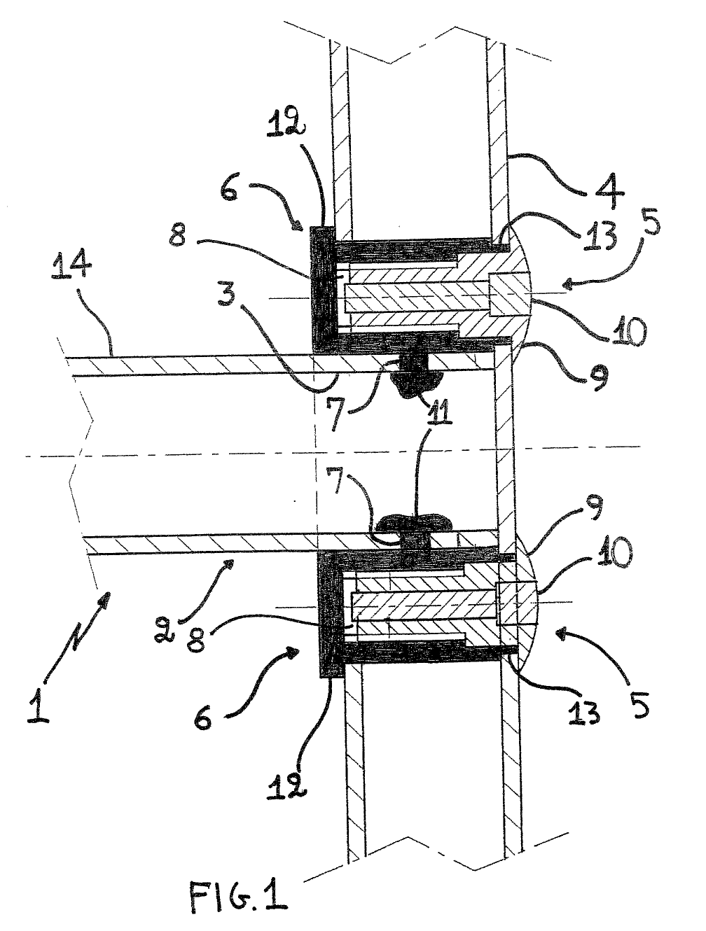

Referring in particular to FIG. 1, a connecting portion 3 positioned at the end of the elongated body 19 is shown; each rung will therefore have two connecting portions 3 at its ends. Rung 1 further comprises engagement means 5, associated with the elongated body 19, adapted to lock the connecting portion 3 to the upright 4; this engagement means 5 advantageously comprises a coupling element 6 made by co-moulding directly on the connecting portion 3 of the elongated body 19.

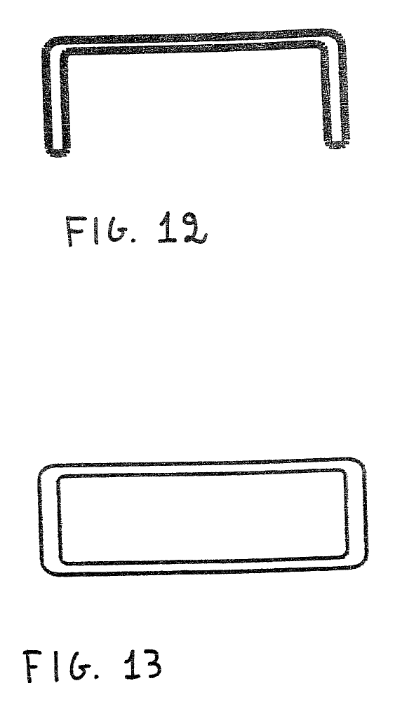

Upright 4 is substantially made up of an axial body 21, on which a plurality of connecting seatings 20 is provided, said seatings being for example obtained by a cutting operation at regular intervals along the axial body 21 itself; the upright is advantageously obtained by forming, and is made of a composite material, preferably fibreglass. The upright section, as shown in FIGS. 12 and 13, can be of any nature, provided it is adapted to withstand the stresses to which it is submitted.

The coupling element 6 is made of a plastic material, preferably nylon.

Structure of the coupling element 6 can be different, depending on whether said element is intended for being associated with the connecting portion 3 of rung 2 or with the connecting seating 20 of the upright 4. In the first case, i.e. when the coupling element is associated with rung 2, the coupling element 6 of same comprises locating extensions 7 operatively interacting with the connecting portion 3 of the elongated body 19. With reference to FIG. 1, said locating extensions 7 essentially consist of excess plastic materials flowing through appropriate locating seats 11 formed on the connecting portion 3 of the elongated body 19. The coupling element 6 further comprises at least one installation housing 8 arranged to receive a mechanical fastener 9 operatively active between the coupling element 6 and the ladder upright 4. With reference to FIG. 1, this mechanical fastener 9 is for example defined by a roundheaded screw; in addition, advantageously provided is the presence of a locking element 10, consisting of a screw anchor for example, the task of which is to prevent accidental disengagement of the mechanical fastener 9.

The coupling element 6 has a section conforming in shape to a connecting housing 20 formed in the upright 4, so as to ensure a correct centering of rung 1 on the upright 4 during the assembling step; in addition, the coupling element 6 has a perimetric abutment region 12 intended to abut against the inner face of the upright 4. At the outer face of the upright 4, the coupling element 6 has a lead-in portion 13 close to the installation housing 8, so that the mechanical fastener 9 is correctly directed during the assembling step.

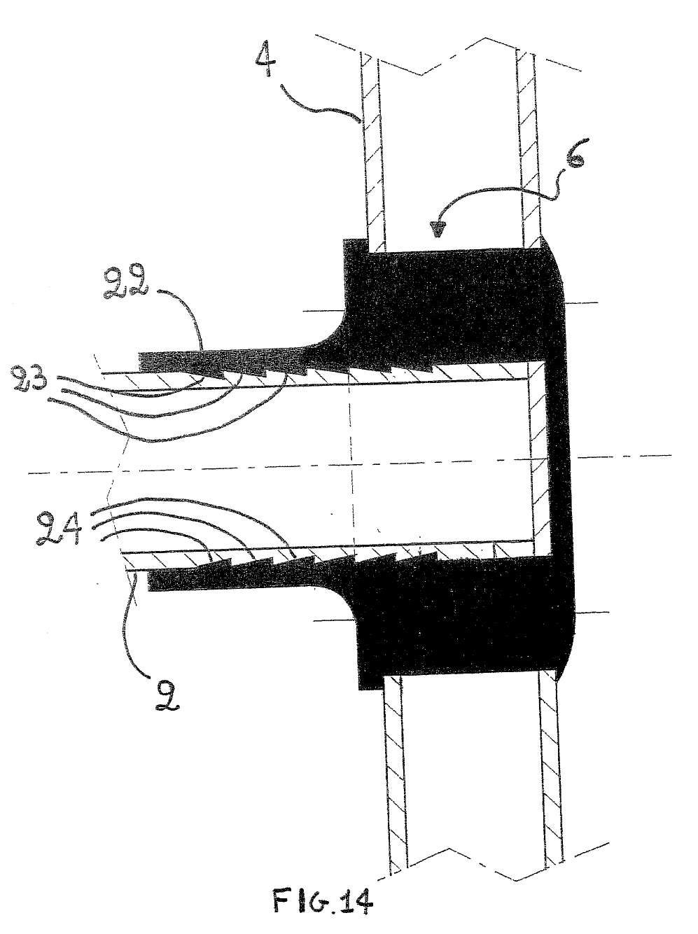

Alternatively, if the coupling element 6 is to be associated with the upright 4, it is co-moulded to a connecting seating 20 formed on the upright 4 by a cutting operation for example. In particular, as viewed from FIG. 14, the coupling element 6 is conformed in shape to the connecting seating 20, so as to ensure a precise assembling without plays that would make the ladder unsteady. The coupling element 6 further comprises a connecting projection 22 substantially shaped in a manner adapted to receive the connecting portion 3 of rung 2 inside it; internally of this connecting projection 22 there are locking ridges 23, consisting for example of indentations on the inner walls of the connecting projection 22, which are adapted to keep the connecting portion 3 of rung 2 in place; obviously, this connecting portion 3 is in this case provided with appropriate locking abutments 24 in engagement with the respective locking ridges 23.

As in the preceding embodiment, the coupling element 6 has installation housings 8 adapted to receive a mechanical fastener 9 equipped with a locking element 10, a screw provided with a screw anchor for example; in this way safe use and capability of being dismantled are ensured to the ladder.

By use of rungs in accordance with the present invention a ladder having at least two uprights 4 can be advantageously built.

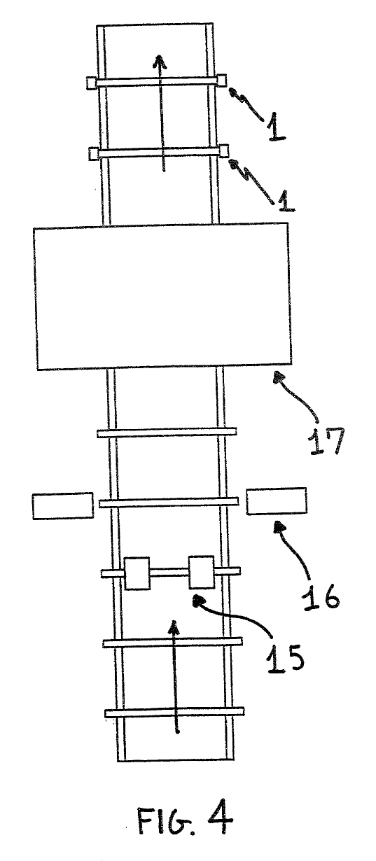

The production line of the concerned ladder is organized in a continuous chain intended for construction of rungs 1 in accordance with the present invention and subsequent assembling of rungs 1 to uprights 4. Construction of the rungs (see FIG. 4) starts from making a section member of composite material by extrusion or pultrusion, said section member being subsequently transversely cut so as to obtain rungs of a preestablished length; at this point the locating seats 11 are obtained, by drilling for example, at the line station 15 and the connecting portions 3 are also obtained by milling at the line station 16; finally, by co-moulding at the line station 17 the coupling element 6 is made on the connecting portion 3. It is important to point out that during co-moulding the abutment extensions 7 are merely obtained by percolation of the plastic material forming the coupling element 6 through said locating seats 11; it should be also noted that in the milling station that portion of the rest surface 14 that could interfere with fitting of rung 1 on the upright 4 is eliminated. Machining of the connecting portion 3 of the rung and co-moulding advantageously also enable manufacture of rungs for tapering ladders, i.e. ladders having their uprights 4 converging from bottom to top; in this case the coupling element 6 will have a suitably modified shape to enable fitting thereof in an upright 4 oriented obliquely of rung 2.

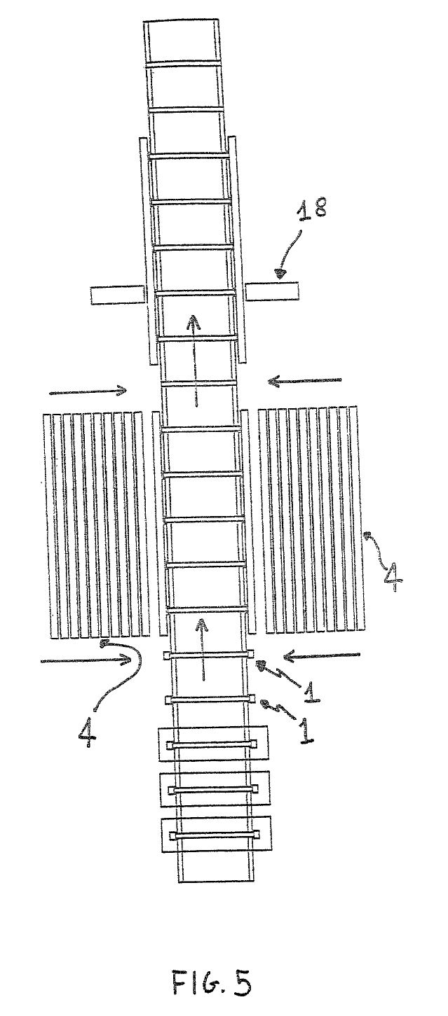

Rungs 1 obtained from the preceding machining operations are subsequently handled along a continuous line in a first feed direction (see FIG. 5); uprights 4 coming from a second handling line defining a second feed direction transverse to the feed direction of rungs 1 converge towards the line carrying these rungs 1. At this point, association of the rungs with the assembling seatings formed on uprights 4 takes place and finally the assembly consisting of a pair of uprights 4 and a preestablished number of rungs is submitted to installation of the mechanical fasteners 9 between rungs 1 and uprights 4, at a screwing station 18 of the line, for example.

The invention achieves important advantages.

It should be noted first of all that formation of the coupling element by co-moulding leads to an important reduction in the production times, since this operation enables elimination of losses of time connected with fitting of the traditional connecting elements at the rung ends and in the installation housing formed on the upright. In addition, the step of making the coupling element by co-moulding promotes setting up of continuous assembly lines, thereby further simplifying the production process.

Another advantage brought about by the presence of such a coupling element results from the great simplicity of construction enabling elimination of the connecting elements installed on ladder uprights of known type and at the same time allowing less complicated working operations to be carried out on the connecting portion of the rung, since the coupling element itself defines the real shape of the rung portion intended for being fitted in the installation housing on the upright.

Use of mechanical fasteners operatively acting in the installation housings of the coupling element also guarantees the possibility of dismantling the ladder while, due to the presence of the locking elements, stability of the mechanical fastener itself is ensured.

Since the rungs are mechanically locked to the uprights by means of elements of easy installation and use, such as screws provided with screw anchors, assembling and disassembling of the ladder by the user is made very easy, if transportation of the ladder in a dismantled configuration is required in order to save room.

Finally, since the coupling element can be made of plastic material, such as nylon for example, the production costs can be greatly reduced as compared with those of the known art, in particular in those cases in which connecting accessories made of metal are required.

In practical accomplishment of the invention, the materials used, shapes and sizes can be of any nature and magnitude depending on requirements.

What is claimed is:

1. A ladder comprising:
a plurality of rungs (2) having each at least one respective connecting portion (3),
at least one upright (4) provided with a plurality of connecting seatings (20),
a plurality of coupling elements (6) interposed each between the connecting portion of a respective rung and the corresponding connecting seating on the upright for connection of said rungs (2) to the connecting seatings (20) of the upright (4), characterized in that said coupling element (6) is made by co-moulding on said portion or said connecting seating.

2. The ladder as claimed in claim 1, characterized in that the coupling element (6) is made by co-moulding on the connecting portion (6) of each rung (2), said coupling element being preferably made of plastic material.

3. The ladder as claimed in claim 1, characterized in that the coupling element is made by co-moulding on a predetermined number of connecting seatings (20) of the upright (4), said coupling element being preferably made of plastic material.

4. The ladder as claimed in claim 1, characterized in that it comprises at least one second upright (4), each rung (2) having the respective ends connected with said uprights (4), said uprights being parallel to or converging towards each other.

5. A rung (2) for ladders preferably of the type in accordance with claim 1, comprising:
an elongated body (19) having at least one connecting portion (3) adapted to engage an upright (4), said elongated body (19) being made of a plastic resin incorporating reinforcing fibres;
engagement means (5) associated with the elongated body (19), adapted to lock the connecting portion (3) to the upright (4), said engagement means (5) comprising a coupling element (6), characterized in that said coupling element (6) is made by co-moulding on the connecting portion (3) of the elongated body (19).

6. The rung as claimed in claim 5, characterized in that said connecting portion (3) is an end portion of the elongated body (19).

7. The rung as claimed in claim 1, characterized in that the coupling element (6) further comprises abutment extensions (7) operatively interacting with the connecting portion (3) of the elongated body (19).

8. The rung as claimed in claim 5, characterized in that the coupling element (6) has at least one installation housing (8), said engagement means (5) comprising a mechanical fastener (9) operatively active in said installation housing (8) between the coupling element (6) and the upright (4).

9. The rung as claimed in claim 5, characterized in that said engagement means (5) comprises at least one locking element (10) active on said mechanical fastener (9) to prevent disengagement of same from the installation seating.

10. The rung as claimed in claim 9, characterized in that said locking element (10) is embodied by a screw anchor.

11. The rung as claimed in claim 5, characterized in that the connecting portion (3) comprises a predetermined number of locating seats (22), said abutment extensions (7) being operatively engaged in said locating seats (11) of the connecting portion (3).

12. The rung as claimed in claim 5, characterized in that the coupling element (6) has a section conforming in shape to a connecting seating (20) formed in the upright (4).

13. The rung as claimed in claim 6, characterized in that the coupling element (6) has a perimetric abutment region (12) adapted to abut against the upright (4).

14. The rung as claimed in claim 6, characterized in that the coupling element (6) has a lead-in portion (13) close to the installation housing (8), said lead-in portion (13) being arranged to receive the mechanical fastener (9).

15. The rung as claimed in claim 5, characterized in that it has a substantially flat rest surface (14), said rest surface (14) being arranged in a substantially horizontal plane under use conditions of the ladder.

16. The rung as claimed in claim 5, characterized in that said rung (2) is a section member, preferably of tubular structure.

17. A process for making rungs for ladders preferably of the type in accordance with claim 5, characterized in that it comprises the steps of:
arranging an elongated body (19) made of plastic resin incorporating reinforcing fibres and having at least one connecting portion (3) adapted to engage an upright (4) of a ladder;
co-moulding to the connecting portion (3), a coupling element (6) for connection of the ladder rung (1) to the ladder upright (4).

18. The process for making rungs for ladders according to claim 17, characterized in that the step of co-moulding the coupling element (6) to the connecting portion (3) simultaneously forms the abutment extensions (7) having a shape conforming to the locating seats (11).

19. The process for making rungs for ladders according to claim 17, characterized in that in the co-moulding step the abutment extensions (7) are formed by forced introduction of the plastic material into the locating seats (11).

20. An upright for ladders preferably of the type in accordance with claim 1, comprising:
an axial body (21) having a plurality of connecting seatings (20) adapted to engage the rung (4), said axial body (21) being made of plastic resin incorporating reinforcing fibres;
engagement means (5) associated with the axial body (21), adapted to lock the connecting seating (20) to the rung (2), said engagement means (5) comprising a coupling element (6), characterized in that said coupling element (6) is obtained by co-moulding on the connecting seating (20) of the axial body (21).

21. The upright as claimed in claim 20, characterized in that the coupling element (6) has a shape conforming to the connecting seating (20) formed on the axial body (21).

22. The upright as claimed in claim 20, characterized in that the coupling element (6) has a connecting projection (22) adapted to house the connecting portion (3) of the rung (2).

23. The upright as claimed in claim 20, characterized in that the connecting projection (22) has a pre-established number of locking ridges (23) adapted to carry out engagement of the connecting portion (3) of the rung (2) with the connecting projection (22).

24. A process for making uprights for ladders preferably of the type in accordance with claim 20, characterized in that it comprises the steps of:
arranging an axial body (21) made of plastic resin incorporating reinforcing fibres and having a preestablished number of connecting seatings (20) adapted to engage a rung (2);
co-moulding the coupling element (6) to the connecting seating (20).

25. A process for making ladders of the type as claimed in claim 5 or of the type as claimed in claim 20, comprising the following steps:
arranging a plurality of rungs (2);
arranging at least two uprights (4);
mechanically locking the rungs (2) to the assembling seatings provided on the uprights (4).

26. The process for making ladders as claimed in claim 25, characterized in that the step of arranging the rungs (2) comprises the following steps:
obtaining the elongated body (19) of composite material by forming;
transversely cutting the elongated body (19) to predetermined lengths;
making the locating seats (11) of the connecting portion (3) by drilling;
working the connecting portions (3) by milling so as to make them ready for assembling with the upright (4);
co-moulding the coupling element (6) on the connecting portions (3) or the connecting seatings (20).

27. The process for making ladders as claimed in claim 25, characterized in that the step of locking the rungs (2) to the uprights (4) comprises the following sub-steps:
handling a plurality of rungs (2) aligned along a first feed direction (15);
handling the uprights (4) along a second feed direction (16) transverse to said first feed direction (15) of the rungs (2);
associating the rungs (2) with the assembling seatings provided on the uprights (4);
installing the mechanical fasteners (9) between the rungs (2) and the uprights (4).
